(19) United States
(12) Patent Application Publication
(10) Pub. No.: US 2020/0133996 A1
(43) Pub. Date: Apr. 30, 2020

(54) SOLVING RANDOM MODULAR SUBSET SUM PROBLEMS

(71) Applicant: Fujitsu Limited, Kawasaki-shi (JP)

(72) Inventors: Avradip Mandal, Sunnyvale, CA (US); Arnab Roy, Santa Clara, CA (US); Hart Montgomery, Redwood City, CA (US)

(73) Assignee: Fujitsu Limited, Kawasaki-shi (JP)

(21) Appl. No.: 16/177,382

(22) Filed: Oct. 31, 2018

(51) Int. Cl. G06F 17/16

(52) U.S. Cl. CPC G06F 17/16

(57) ABSTRACT

According to an aspect of an embodiment, a method may include obtaining a plurality of random integers, a divisor, and a remainder associated with a random modular subset sum problem and generating an Ising Model connection weight matrix “W”, at least some elements of the matrix “W” may be determined based on the plurality of random integers. The method may also include generating an Ising Model bias vector “b”, elements of the vector “b” be may be determined based on the remainder. The method may also include providing the matrix “W” and the vector “b” to an annealing system configured to solve problems written according to the Ising Model and obtaining an output from the annealing system that represents a set of integers of the plurality of random integers. The method may also include using the set of integers as a solution to the random modular subset sum problem.

### FIELD

The embodiments discussed herein are related to a method and/or system for solving random modular subset sum problems.

### BACKGROUND

Random modular subset sum problems are in a class of problems that may be difficult to solve. As a result, random modular subset sum problems and their corresponding solutions may be used in various technical fields such as cryptology and cryptanalysis.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include obtaining a plurality of random integers, a divisor, and a remainder associated with a random modular subset sum problem and generating an Ising Model connection weight matrix “W”. In some embodiments, at least some elements of the matrix “W” may be determined based on the plurality of random integers. The method may also include generating an Ising Model bias vector “b”. In some embodiments, elements of the vector “b” may be determined based on the remainder. The method may also include providing the matrix “W” and the vector “b” to an annealing system configured to solve problems written according to the Ising Model and obtaining an output from the annealing system that represents a set of integers of the plurality of random integers. In some embodiments, a sum of the set of integers divided by the divisor may result in an integer quotient and the remainder. The method may also include using the set of integers as a solution to the random modular subset sum problem defined by the plurality of random integers, the divisor, and the remainder.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment related to solving random modular subset sum (RMSS) problems;

FIG. 2 illustrates an example computing system that may be configured for solving RMSS problems; and

FIG. 3 is a flowchart of an example method for solving RMSS problems.

### DESCRIPTION OF EMBODIMENTS

Random Modular Subset Sum problems (RMSS) may include a class of optimization problems having a variety of applications including cryptanalysis, among others. In addition, digital and quantum annealing systems may use a heuristic approach to obtain solutions to optimization problems in a manner that is faster than classical computing systems and techniques. As such, digital or quantum annealing systems may be useful in helping solve RMSS problems, which may improve some technical fields such as cryptanalysis. For purposes of brevity, references to the digital and/or quantum annealer will be referred to jointly as “annealer.”

In some embodiments, inputs typically used to solve RMSS problems may not be configured in a manner that allows an annealing system to solve the RMSS problem efficiently. In some embodiments, an Ising Model may be used to solve an RMSS problem; however, RMSS and Ising Model problems may need to be converted in a way that efficiently reduces the inputs. Thus, according to one or more aspects of the present disclosure, one or more operations may be performed with respect to an RMSS problem in order to obtain Ising Model inputs that may be re-input to solve the RMSS problem.

As such, according to one or more embodiments of the present disclosure, the operations described herein allow for an improvement in annealing systems by providing a mechanism that enables the annealing systems to solve RMSs problems using an efficient reduction of both the original RMSS equation and the Ising Model problem. In some embodiments, the efficiency of the method is related to the efficiency of the annealer. The methods described herein may not incorporate generic reductions, avoiding polynomial blowup in instance size, which may result in exponential degradation of efficiency.

Embodiments of the present disclosure are explained with reference to the accompanying drawings.

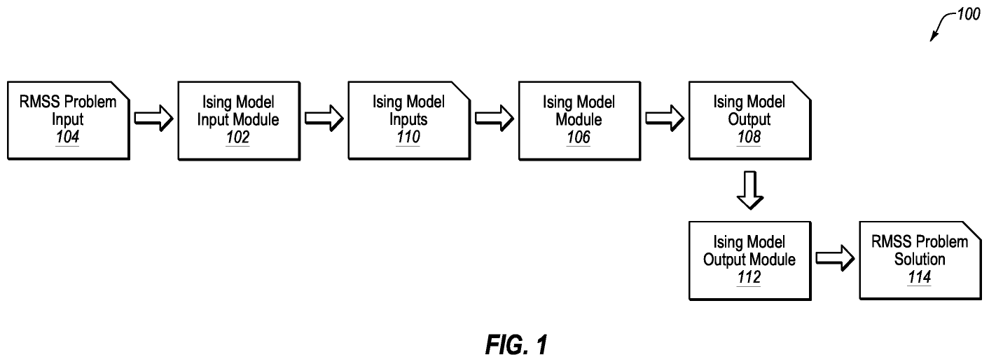

FIG. 1 is a diagram representing an example environment 100 related to solving RMSS problems using an annealing system, arranged in accordance with at least one embodiment described in the present disclosure. The environment 100 may include an Ising model input module 102 (“input module 102”), an Ising model Module 106 (“Ising module 106”), and an Ising model output module 112 (“output module 112”).

The input module 102, the Ising module 106, and/or the output module 112 may include code and routines configured to enable a computing device to perform one or more of the operations described therewith. Additionally or alternatively, the input module 102, the Ising module 106, and/or the output module 112 may be implemented using hardware including any number of processors, microprocessors (e.g., to perform or control performance of one or more operations), field-programmable gate arrays (FPGAs), application-specific integrated circuits (ASICs) or any suitable combination of two or more thereof.

Alternatively or additionally, the input module 102, the Ising module 106, and/or the output module 112 may be implemented using a combination of hardware and software. In the present disclosure, operations described as being performed by the input module 102, the Ising module 106, and/or the output module 112 may include operations that the input module 102, the Ising module 106, and/or the output module 112 may direct a corresponding system to perform.

In some embodiments, the input module 102, the Ising module 106, and the output module 112 may each be included in an annealing system (e.g., a digital annealing system or a quantum annealing system). Additionally or alternatively, the Ising module 106 may be included in the annealing system and one or more of the input module 102 and the output module 112 may be included in a separate system that is configured to interface with the annealing system. Further, the input module 102, the Ising module 106, and the output module 112 are illustrated and described as separate elements to facilitate explanation of the present disclosure. As such, any suitable hardware and/or software arrangement configured to perform the operations described as being performed by the input module 102, the Ising module 106, and the output module 112 is within the scope of the present disclosure.

A random module subset sum (RMSS) problem may be defined as seeking a subset T of a set S of n random integers {a₁, a₂, . . . , aₙ} where the sum of the elements of T is c modulo (mod) q where q is an integer divisor and c is an integer remainder. In the above, n may represent the number of integers in the set. For example, for the set {1, 3, 4, 7, 9 10, 11}, n may equal seven. For this set, where q is 3 and c is 2, the subset T may include {1, 3, 4, and 9} because the sum of {1, 3, 4, and 9} is 17 and 17 mod 3 results in a remainder of 2.

In some embodiments, the subset T may include one or more integers of the set S. Given the set S of n integers, any one of the variables, T, q, and c may be determined if the other variables are provided.

In some embodiments, a RMSS problem may be a nondeterministic polynomial time complete (NP-complete) problem. In these and other embodiments, for RMSS problems it may be easy to confirm whether a proposed solution is valid, but it may be difficult to determine whether a solution exists for a set of integers. In some embodiments, the difficulty of determining a solution may be based on a relationship between the number n of elements in the set of integers and the divisor q. In these and other embodiments, the difficulty in determining a solution may be related to a density of the RMSS. For example, the density d of the RMSS may be based on the following:

$$d = \frac{n}{log q} \qquad ( 1 )$$

In these and other embodiments, the RMSS problem may be more difficult to solve when the density d is approximately equal to 1. When the density d is far from 1, then the RMSS problem may be solved more easily or may not have a likely solution.

In some embodiments, the RMSS problem inputs 104 may include a set S of n number of random integers, integer divisor q, and integer remainder c. The RMSS problem input 104 may be provided to the input module 102.

The input module 102 may be configured to perform one or more operations with respect to the RMSS problem input 104 to generate the Ising model inputs 110. The input module 102 may be configured to generate the Ising model inputs 110 such that the Ising model inputs 110 may be used by the Ising module 106 to solve the RMSS problem.

For example, the Ising module 106 may be configured to performs a Markov Chain Monte Carlo (MCMC) stochastic search to minimize Ising energy by finding an output vector “X” in the following expression (2) of Ising energy that minimizes the Ising Energy:

E(X)=−Σ_{{i,j}}Wᵢⱼxᵢxⱼ−Σᵢbᵢxᵢ,(i=1,2, . . . ,N) (2)

where xᵢ∈{0, 1} is the state variable or bit, X=(x₁, x₂, . . . x_{N}) is the vector representation of the state variable, N is the number of bits, “W” is an Ising model connection weight matrix that weighs the connections between elements of the output vector “x” and “b” is a bias vector used in determining the Ising Energy.

In some embodiments, the Ising module 106 may include an information processing apparatus that may include one or more Ising units. The Ising units may be configured to perform an operation of an Ising energy function of a neural network by small-scale hardware based on an algorithm such as the DeGloria algorithm. The elements in the matrix W may include weighting values between neurons of the neural network. For example, an element in the matrix W may include a weighting value between a first neuron represented by row number in the matrix W and a second neuron represented by a column number in the matrix W, where the row and column number identify the element. The information processing apparatus may work to minimize the energy in the neural network to determine a solution to a problem represented by the matrix W and vector b.

An example of an information processing apparatus that includes Ising units is provided in U.S. Publication No. 2018/0075342, filed on Aug. 30, 2017 and incorporated in this disclosure in its entirety. As described in U.S. Publication No. 2018/0075342, the Ising units may include an energy value calculation circuit and a state transition determination circuit. The energy value calculation circuit may be configured to calculate an energy value, which is based on a value of one or more of the elements in the matrix “W”, that may be used to generate the output of the information processing apparatus. The output may include a solution to the problem represented by the matrix W and vector b. Additional information and examples of the state transition determination circuit is provided in U.S. Publication No. 2018/0107172, filed on Sep. 28, 2017 and incorporated in this disclosure in its entirety.

In some embodiments, the input module 102 may be configured to generate the Ising model connection weight matrix “W” and the bias vector “b” based on the RMSS problem input 104.

An example of how the RMSS problem may be defined to result in the matrix “W” and the vector “b” is now provided. Note that the Ising model functions by minimizing the output.

In this example, the parameters of a set S of a n integers may be represented by ( [symbol] aᵢ [symbol] ᵢ₌₁ⁿ). The parameters may also include the divisor q and the remainder c. Note that a solution to the RMSS problem is a sum of the elements of Tis c mod q. However, the solution may also be considered the sum of the elements of T, when c is subtracted, being a value that is evenly divisible by q with no remainder. Based on this understanding, given the RMSS problem inputs, the following quantity may be considered:

H₁=(Σᵢ₌₁ⁿxᵢaᵢ−c)² (3)

where xᵢ∈{0,1}. In this quantity, if there is a subset of multiple aᵢ values that sum up to c, then H₁ will be minimized by picking up the corresponding multiple xᵢ values as equal to 1, and the rest of the values as equal to 0.

Additionally, in the RMSS problem, the sum of the elements of T may be given modulo q. For example, if q is 15, then the numbers 30, 45, 60, 75, 90, 105, etc may all be mapped to 0 mod q. To account for this rounding over multiples of q, the energy function of expression (3) may be adapted as shown below in equation (4):

H₂=(Σᵢ₌₁ⁿxᵢaᵢ−yq−c)² (4)

where xᵢ∈{0,1}, y∈ [symbol] . In this example, the variable y may represent the closest multiple of q that the subset sum is greater or equal to.

In some embodiments, the Ising module 106 may be configured to perform the operations based on a binary input so that the equation is a pure binary optimization problem. Equation (3) is in a binary input as xᵢ∈{0,1}. However, the term yq is not in a binary input. To convert the term yq to a binary input, the maximum possible value of y may be determined as follows in equation (5).

$$⌊ \frac{{\sum }_{i = 1}^{n} {a}_{i}}{q} ⌋ \qquad ( 5 )$$

Note that the maximum value of y is a sum of the entire set S divided by the divisor q. A binary representation of y may be defined by tin equation (6) as follows:

$$t = ⌈ log ( ⌊ \frac{{\sum }_{i = 1}^{n} {a}_{i}}{q} ⌋ ) ⌉ \qquad ( 6 )$$

Based on the binary representation of y, the equation (4) may be adapted as follows:

H=(Σᵢ₌₁ⁿxᵢaᵢ−qΣⱼ₌₀^{t}2^{j}yⱼ−c)² (7)

Equation (7) thus represents a quadratic binary optimization problem. A number of binary unknowns that may be solved for in equation (7) is n+t. The binary unknowns in the equation (7) may include xᵢ and yᵢ. Based on equation (7), the solution vector may be represented as (x₁ . . . xₙ y . . . yₜ)^{T}. In the solution vector, when an xᵢ=1, then the corresponding element aᵢ may be part of the solution subset T. If xᵢ=0, then the corresponding element aᵢ may not be part of the solution subset T. The y's from the solution vector may not be part of the solution of the RMSS problem.

Based on the quadratic binary optimization problem represented in equation (7), the solution vector representation provided, the matrix W and the bias vector b being functions of the set S of aᵢ, q, and c, and the number of unknowns that may be solved for being bounded by n+t, the elements of the matrix Wᵢⱼ may be computed as:

$$[ \begin{matrix}{a}_{i}^{2} , & 0 \leq i = j \leq \\ 2 {a}_{i} {a}_{j} , & 0 \leq i < j \leq n \\ {q}^{2} {2}^{2 ( i - n )} , & n + 1 \leq i = j \leq n + t \\ {q}^{2} {2}^{i + j - 2 n + 1} , & n + 1 \leq i < j \leq n + t \\ - q {a}_{i} {2}^{j - n + 1} , & 0 \leq i \leq n , n + 1 \leq j \leq n + t \\ 0 , & all other cases\end{matrix} ]$$

and the elements of the vector bᵢ may be computed as:

$$[ \begin{matrix}- 2 c {a}_{i} & 0 \leq i \leq n \\ cq {2}^{i - n + 1} & n + 1 \leq i \leq n + t\end{matrix} ]$$

The computed matrix W and vector b may be computed as the Ising model inputs 110. The Ising model inputs 110 may be provided to the Ising module 106.

In these or other embodiments, the input module 102 may be configured to provide the Ising model inputs 110 to the Ising module 106. The Ising module 106 may be configured to solve optimization problems written according to the Ising optimization model described above. In addition, as also indicated above, the Ising module 106 may be part of the annealing system such that the annealing system is able to use the Ising optimization model to solve optimization problems in a much faster manner than classically configured computing systems. In these or other embodiments, the Ising module 106 may be configured to generate an Ising model output 108 as a solution to the optimization problem.

Based on the determined weight matrix “W” and the determined bias vector “b”, which as described above are determined according to the set S of aᵢ, q, and c and the RMSS problem, the Ising module 106 may be configured to determine the output vector (x₁ . . . xₙ y . . . yₜ)^{T} that represents the elements of subset T where the sum of the elements of T equals c mod q. As such, the annealing system may be able to solve the RMSS problem using the Ising module 106 and the model inputs 110 generated by the input module 102. In these or other embodiments, the output vector may be included in the Ising model output 108.

In some embodiments, the Ising module 106 may be configured to generate the Ising model output 108 in a binary representation. In these or other embodiments, the output module 112 may receive the Ising model output 108. The output module 112 may be configured to convert the Ising model output 108 from binary representation to a decimal representation that may be output as the RMSS problem solution 114.

In some embodiments, the RMSS problem solution 114 may be used in various situations. For example, the RMSS problem may be used in cryptology. In these and other embodiments, a set of random integers may be generated. The process described with respect to FIG. 1 may be used to determine a solution of the RMSS problem for the set of random integers. The solution and the set of random integers may be used together as public/private keys in a cryptographic configuration. For example, a public/private key encryption scheme is described in A Fast Heuristic Algorithm for Solving High Density Subset Sum Problems by Akash Nag, Published Online April 2017 in MECS (http://www.mecs-press.net), Cryptanalysis of Knapsack Cryptography, Georgia Tech Fall 2013, https://web.eecs.umich.edu/˜cpeikert/lic13/lec05.pdf; and Mandal, Avradip, and Arnab Roy. “Relational Hash: Probabilistic hash for verifying relations, secure against forgery and more.” Annual Cryptology Conference. Springer, Berlin, Heidelberg, 2015, all of which are incorporated herein by reference in their entirety.

Alternatively or additionally, the RMSS problem solution 114 may be used in cryptanalysis to study a cryptographic configuration that employs an RMSS solution. In these and other embodiments, the RMSS problem solution 114 may be used to determine alternatively possible solutions to a cryptographic configuration, among other uses.

Modifications, additions, or omissions may be made to FIG. 1 without departing from the scope of the present disclosure. For example, the environment 100 may include more or fewer elements than those illustrated and described in the present disclosure.

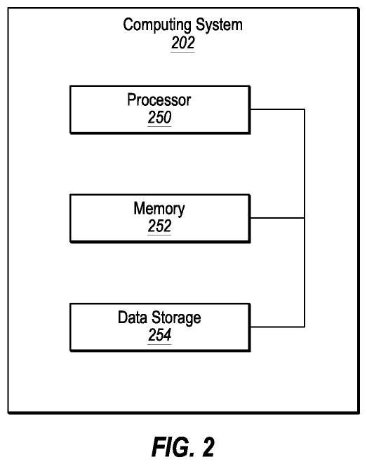

FIG. 2 illustrates a block diagram of an example computing system 202 configured to solve RMSS related problems, according to at least one embodiment of the present disclosure. The computing system 202 may be configured to implement or direct one or more operations associated with an Ising model input module (e.g., the input module 102 of FIG. 1), an Ising model module (e.g., the Ising module 106 of FIG. 1), and/or an Ising model output module (e.g., the output module 112 of FIG. 1). In some embodiments, the computing system 202 may be included in or form part of an annealing system. The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 250 may include any number of processors configured to, individually or collectively, perform or direct performance of any number of operations described in the present disclosure. Additionally, one or more of the processors may be present on one or more different electronic devices, such as different servers.

In some embodiments, the processor 250 may be configured to interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

The memory 252 and the data storage 254 may include computer-readable storage media for carrying or having computer-executable instructions or data structures stored thereon. Such computer-readable storage media may include any available non-transitory media that may be accessed by a general-purpose or special-purpose computer, such as the processor 250. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

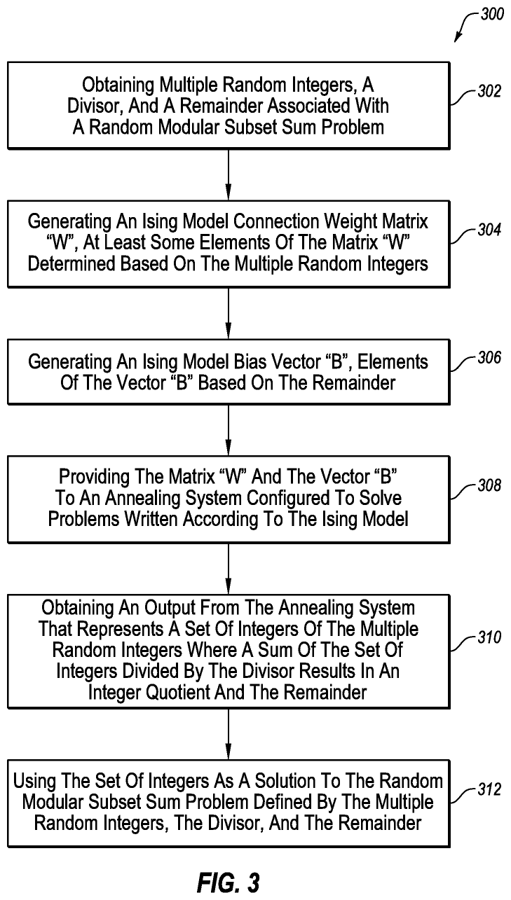

FIG. 3 illustrates a flowchart of an example method 300 of solving RMSS problems according to at least one embodiment described in the present disclosure. The method 300 may be performed by any suitable system, apparatus, or device. For example, the environment 100 of FIG. 1 or the computing system 200 of FIG. 2 may perform one or more of the operations associated with the method 300. Although illustrated with discrete blocks, the steps and operations associated with one or more of the blocks of the method 300 may be divided into additional blocks, combined into fewer blocks, or eliminated, depending on the particular implementation.

The method 300 may begin at block 302, where multiple random integers, a divisor, and a remainder associated with a random modular subset sum problem may be obtained. In some embodiments, a number of the multiple random integers divided by a log of the divisor may be approximately equal to one. In some embodiments, the divisor and the remainder may both be integers.

In block 304, an Ising Model connection weight matrix “W” may be generated. In some embodiments, at least some elements of the matrix “W” may be determined based on the multiple random integers.

Alternatively or additionally, a first portion of the elements of the matrix “W” may be based only on the multiple random integers and a second portion of the elements of the matrix “W” may be based only on the divisor. In these and other embodiments, the first portion of the elements of the matrix “W” being based only on the multiple random integers may include mathematical manipulations of the multiple random integers. Alternatively or additionally, the second portion of the elements of the matrix “W” being based only on the divisor may include mathematical manipulations of the divisor.

Alternatively or additionally, a first portion of the elements of the matrix “W” may be zero, a second portion of the elements of the matrix “W” may be based only on one or more of the multiple random integers, a third portion of the elements of the matrix “W” may be based only on the divisor, and a fourth portion of the elements of the matrix “W” may be based only on the divisor and the multiple random integers. In these and other embodiments, the second portion of the elements of the matrix “W” being based only on one or more of the multiple random integers may include mathematical manipulation of the multiple random integers. Alternatively or additionally, the third portion of the elements of the matrix “W” being based only on the divisor may include mathematical manipulation of the divisor. Alternatively or additionally, the fourth portion of the elements of the matrix “W” being based only on the divisor and the multiple random integers may include mathematical manipulation of the divisor and the multiple random integers.

In some embodiments, a first dimension of the matrix “W” may be equal to a number of the multiple random integers and a second dimension of the matrix “W” may be equal to a sum of the number of the multiple random integers and a log of “y”. In these and other embodiments, “y” may be the sum of the multiple random integers divided by the divisor.

In block 306, an Ising Model bias vector “b” may be generated. In some embodiments, elements of the vector “b” may be determined based on the remainder. In some embodiments, a first portion of the elements of the vector “b” may be based only on the remainder and the multiple random integers and a second portion of the elements of the vector “b” may be based only on the remainder and the divisor.

In these and other embodiments, the first portion of the elements of the vector “b” being based only on the remainder and the multiple random integers may include mathematical manipulation of the remainder and the multiple random integers. The second portion of the elements of the vector “b” being based only on the remainder and the divisor may include mathematical manipulation of the remainder and the divisor.

In block 308, the matrix “W” and the vector “b” may be provided to an annealing system configured to solve problems written according to the Ising Model. In block 310, an output may be obtained from the annealing system that represents a set of integers of the multiple random integers. In some embodiments, a sum of the set of integers divided by the divisor may result in an integer quotient and the remainder.

In block 312, the set of integers may be used as a solution to the random modular subset sum problem defined by the multiple random integers, the divisor, and the remainder. In some embodiments, the multiple random integers, the divisor, and the remainder may be obtained from a cryptographic hashing technique and the using the set of integers may include providing the set of integers to a system applying the cryptographic hashing technique to gain access to the system.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method, the method comprising:
obtaining a plurality of random integers, a divisor, and a remainder associated with a random modular subset sum problem;
generating an Ising Model connection weight matrix “W”, at least some elements of the matrix “W” determined based on the plurality of random integers;
generating an Ising Model bias vector “b”, elements of the vector “b” determined based on the remainder;
providing the matrix “W” and the vector “b” to an annealing system configured to solve problems written according to the Ising Model;
obtaining an output from the annealing system that represents a set of integers of the plurality of random integers where a sum of the set of integers divided by the divisor results in an integer quotient and the remainder; and
using the set of integers as a solution to the random modular subset sum problem defined by the plurality of random integers, the divisor, and the remainder.

2. The method of claim 1, wherein the annealing system includes an energy value calculation circuit configured to calculate an energy value used to generate the output, wherein the energy value is based on a value of one or more of the elements in the matrix “W”.

3. The method of claim 1, wherein a first dimension of the matrix “W” is equal to a number of the plurality of random integers and a second dimension of the matrix “W” is equal to a sum of the number of the plurality of random integers and a log of “y” where “y” is the sum of the plurality of random integers divided by the divisor.

4. The method of claim 1, wherein a first portion of the elements of the matrix “W” determined are based only on the plurality of random integers and a second portion of the elements of the matrix “W” determined are based only on the divisor.

5. The method of claim 1, wherein a first portion of the elements of the matrix “W” are zero, a second portion of the elements of the matrix “W” are based only on one or more of the plurality of random integers, a third portion of the elements of the matrix “W” are based only on the divisor, and a fourth portion of the elements of the matrix “W” are based only on the divisor and the plurality of random integers.

6. The method of claim 1, wherein a first portion of the elements of the vector “b” are based only on the remainder and the plurality of random integers and a second portion of the elements of the vector “b” are based only on the remainder and the divisor.

7. The method of claim 1, wherein a number of the plurality of random integers divided by a log of the divisor is approximately equal to one.

8. One or more non-transitory computer-readable storage media configured to store instructions that, in response to being executed, cause a system to perform operations, the operations comprising:
obtaining a plurality of random integers, a divisor, and a remainder associated with a random modular subset sum problem;
generating an Ising Model connection weight matrix “W”, at least some elements of the matrix “W” determined based on the plurality of random integers;
generating an Ising Model bias vector “b”, elements of the vector “b” determined based on the remainder;
providing the matrix “W” and the vector “b” to an annealing system configured to solve problems written according to the Ising Model;
obtaining an output from the annealing system that represents a set of integers of the plurality of random integers where a sum of the set of integers divided by the divisor results in an integer quotient and the remainder; and
using the set of integers as a solution to the random modular subset sum problem defined by the plurality of random integers, the divisor, and the remainder.

9. The one or more non-transitory computer-readable storage media of claim 8, wherein the plurality of random integers, the divisor, and the remainder are obtained from a cryptographic technique.

10. The one or more non-transitory computer-readable storage media of claim 8, wherein a first dimension of the matrix “W” is equal to a number of the plurality of random integers and a second dimension of the matrix “W” is equal to a sum of the number of the plurality of random integers and a log of “y” where “y” is the sum of the plurality of random integers divided by the divisor.

11. The one or more non-transitory computer-readable storage media of claim 8, wherein a first portion of the elements of the matrix “W” determined are based only on the plurality of random integers and a second portion of the elements of the matrix “W” determined are based only on the divisor.

12. The one or more non-transitory computer-readable storage media of claim 8, wherein a first portion of the elements of the matrix “W” are zero, a second portion of the elements of the matrix “W” are based only on one or more of the plurality of random integers, a third portion of the elements of the matrix “W” are based only on the divisor, and a fourth portion of the elements of the matrix “W” are based only on the divisor and the plurality of random integers.

13. The one or more non-transitory computer-readable storage media of claim 8, wherein a first portion of the elements of the vector “b” are based only on the remainder and the plurality of random integers and a second portion of the elements of the vector “b” are based only on the remainder and the divisor.

14. A system comprising:
one or more computer-readable storage media configured to store instructions; and
one or more processors communicatively coupled to the one or more computer-readable storage media and configured to, in response to execution of the instructions, cause the system to perform operations, the operations comprising:
obtaining a plurality of random integers, a divisor, and a remainder associated with a random modular subset sum problem;
generating an Ising Model connection weight matrix “W”, at least some elements of the matrix “W” determined based on the plurality of random integers;
generating an Ising Model bias vector “b”, elements of the vector “b” determined based on the remainder;
providing the matrix “W” and the vector “b” to an annealing system configured to solve problems written according to the Ising Model;
obtaining an output from the annealing system that represents a set of integers of the plurality of random integers where a sum of the set of integers divided by the divisor results in an integer quotient and the remainder; and
using the set of integers as a solution to the random modular subset sum problem defined by the plurality of random integers, the divisor, and the remainder.

15. The system of claim 14, wherein the plurality of random integers, the divisor, and the remainder are obtained from a cryptographic technique.

16. The system of claim 14, wherein a first dimension of the matrix “W” is equal to a number of the plurality of random integers and a second dimension of the matrix “W” is equal to a sum of the number of the plurality of random integers and a log of “y” where “y” is the sum of the plurality of random integers divided by the divisor.

17. The system of claim 14, wherein a first portion of the elements of the matrix “W” determined are based only on the plurality of random integers and a second portion of the elements of the matrix “W” determined are based only on the divisor.

18. The system of claim 14, wherein a first portion of the elements of the matrix “W” are zero, a second portion of the elements of the matrix “W” are based only on one or more of the plurality of random integers, a third portion of the elements of the matrix “W” are based only on the divisor, and a fourth portion of the elements of the matrix “W” are based only on the divisor and the plurality of random integers.

19. The system of claim 14, wherein a first portion of the elements of the vector “b” are based only on the remainder and the plurality of random integers and a second portion of the elements of the vector “b” are based only on the remainder and the divisor.

20. The system of claim 14, wherein a number of the plurality of random integers divided by a log of the divisor is approximately equal to one.
